(19) United States
(12) Patent Application Publication
(10) Pub. No.: US 2006/0103388 A1
(43) Pub. Date: May 18, 2006

(54) Method for compensating dielectric attenuation in downhole galvanic measurements

(75) Inventors: Stanislav W. Forgang, Houston, TX (US); Gregory B. Itskovich, Houston, TX (US); Randy Gold, Houston, TX (US); Homero Castillo, Kingwood, TX (US)

Correspondence Address: LOCKE LIDDELL & SAPP LLP;ATTN: SUE COTT, 2200 ROSS AVENUE, SUITE 2200, DALLAS, TX, 75201-6776, US

(73) Assignee: Baker Hughes Incorporated

(21) Appl. No.: 10/986,096

(22) Filed: Nov. 12, 2004

(51) Int. Cl. G01V 3/18

(52) U.S. Cl. 324/338

(57) ABSTRACT

A method for estimating resistivity of a formation includes exciting an alternating current in the formation through non-conductive mud within a bore hole in the formation using a circuit. The circuit includes a known inductor and the non-conductive mud. A circuit response is measured. The complex impedance of the circuit is computed using the measured response to estimate the resistivity of the formation.

### TECHNICAL FIELD OF THE INVENTION

The present invention relates to methods and apparatus for investigating sub-surface earth formations, and in particular to methods and apparatus for measuring the electrical resistivity or conductivity of the earth formation adjacent to a bore hole passing through terrestrial formations.

### BACKGROUND OF THE INVENTION

The electrical resistivity or conductivity of sub-surface earth formations is typically investigated by moving a system of electrodes, suspended at the end of a cable, through a bore hole. Current emitted from one or more of these electrodes is caused to flow into the formation surrounding the bore hole. By measuring the flow of current and/or the electrical potential at various points within the bore hole, signals representative of the resistivity or conductivity of the formation surrounding the bore hole are obtained. The signals are useful in determining the presence and depth of oil or gas bearing formations.

A requirement of electrical logging for the investigation of earth formations is the presence of a conductive fluid in the bore hole to permit the passage of conductive current from the electrode system into the formation. Bore holes are often drilled with a non-conductive fluid, for example, or “oil-based” drilling mud which high electrical resistance makes it difficult to make resistivity measurements. This problem is further increased when an oil-based drilling mud cakes or significant invasion are present.

Methods for collecting data of downhole conditions and movement of the drilling assembly during the drilling operation are known as measurement-while-drilling (MWD) techniques. An approach to the problem of measuring formation parameters in bore holes having non-conductive fluid involves the use of a high frequency signal to capacitively couple an electrode system through the non-conductive fluid to the bore hole wall.

Galvanic instruments are used in MWD and suffer from a “high ground resistance problem” while operating in the well filled with non-conductive mud. This resistance between the tool's electrodes consists of the mud and formation impedances connected, primarily, in series. The oil-based mud component exhibits capacitive behavior, significantly attenuates the test current flow and produces unwanted out-of-phase component in the measured signals.

As galvanic instruments are used more frequently in MWD operations, increasing the driving voltage applied between the source and return electrodes and increasing frequency of operation have been utilized to overcome the above-identified problem; however a need exists for compensation of unwanted dielectric attenuation in the test current flowing between the source and return electrodes.

A need has thus arisen for a method and apparatus to compensate for unwanted dielectric attenuation of a test current flowing in a path between the source and return electrode paths while the tool is operating in a bore hole filled with non-conductive oil-based mud.

### SUMMARY OF THE INVENTION

In accordance with the present invention, a method for estimating resistivity of a formation is provided. The method includes exciting an alternating current in the formation through non-conductive mud within a bore hole in the formation using a circuit. The circuit includes a known inductor and the non-conductive mud. A circuit response is measured. The complex impedance of the circuit is computed using the measured response to estimate the resistivity of the formation.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a schematic block diagram of the present measurement circuit;

FIG. 2 is a graph of current versus frequency illustrating operation of the present method in a sweeping mode; and

FIG. 3 is a graph of current versus time illustrating operation of the transient mode of the present method.

### DESCRIPTION OF THE PREFERRED EMBODIMENTS

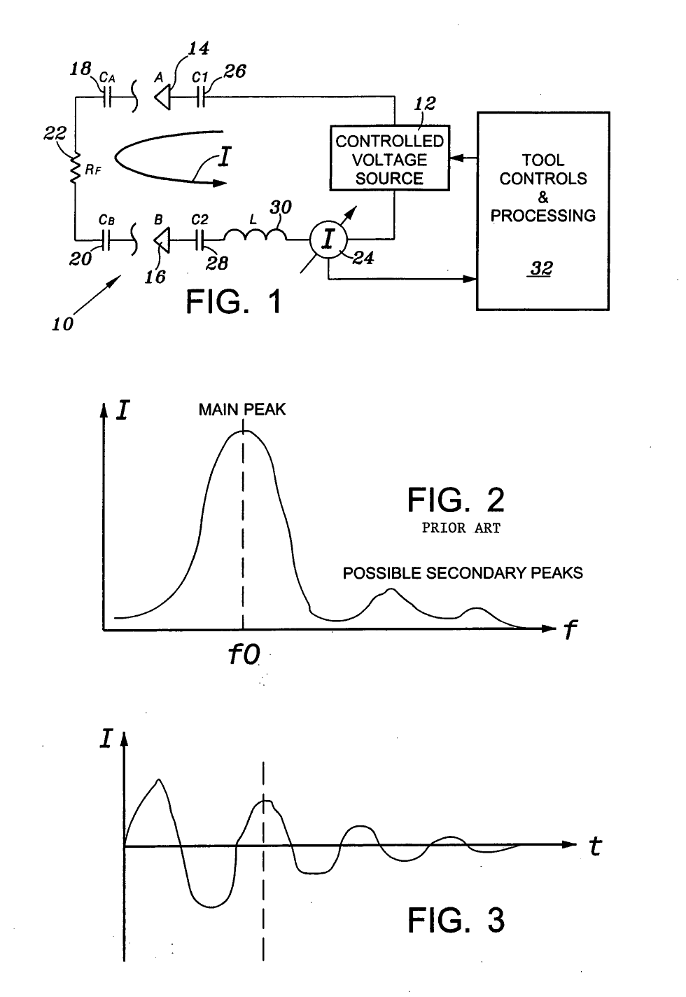

Referring to FIG. 1, a driving circuit for resistivity galvanic tools is illustrated, and generally identified by the numeral 10. Circuit 10 includes a source of driving voltage 12, a source electrode, A 14 and a return electrode B, 16. Current, I, established from voltage source 12 flows to the mud in the bore hole from electrode 14, then into the formation, and returns to electrode 16 through the mud. The impedances of the mud and formation are respectively presented by capacitive elements C_{A}, 18 and C_{B}, 20 for the mud and active losses R_{F}, 22 for the formation. In the case of logging or MWD in non-conductive, oil-based, mud the parasitic attenuation presented by the mud impedance can become very large and in many cases results in poor measurement quality.

The present circuit 10 is utilized to correct the above-stated problem by introducing a permanent inductor together with two capacitors connected in series in the test current loop 24. A capacitor C1, 26 is connected to source electrode 14. A capacitor C2, 28 is connected to return electrode 16. Inductor, L, 30 is connected in series with capacitor 28 or capacitor 26. Circuit 10 is energized by voltage source 12 and the circuit 10 current is measured at current loop 24. The operation of circuit 10 is under control provided by tool controls and processing 32.

Capacitors 26 and 28 establish a maximum capacitance the circuit 10 could see in well operation. If for any operational reason, the mud becomes conductive or the tool pad touches the well bore wall, the equivalent capacitance disappears and only the capacitance of capacitors 26 and 28 exist. Capacitors 26 and 28 connected in series with permanent inductor 30 establish minimum operational tool frequency expressed as follows:

$$f = \frac{1}{\sqrt{C \cdot L}} \qquad ( 1 )$$

where total capacitance C will be the tool capacitance as follows:

$$Ct = \frac{C 1 \cdot C 2}{C 1 + C 2} \qquad ( 2 )$$

In practice, capacitors 26 and 28 are formed by insulation layer deposited on the external surface of the electrodes 14 and 16.

While operation in non-conductive environment, the total capacitance C connected in series with inductor 30 will decrease further as:

$$C = \frac{Ct \cdot ( CA + CB )}{Ct + CA + CB} \qquad ( 3 )$$

which would result in rising the frequency f.

The present tool operation functions in one of two modes, sweeping the voltage source 12 frequency and a transient mode.

In the sweeping mode the frequency f is increased from the above-mentioned value up until overall circuit series residence at f 0 has been reached. The tuning curve for circuit 10 has a well-known shape of a single pole resonance and is illustrated in FIG. 2.

The magnitude of the current upon reaching resonance is:

$$I = \frac{V}{{R}_{F}} \qquad ( 4 )$$

However, the width of the curve would be determined by the circuit 10 electrical quality which is a function of both formation's active load RF 22 and circuit reactance. Therefore determining the quality Q helps in quantization of mud properties to use for further interpretation. Sweeping frequency far above the main circuit resonance is beneficial as such action would light secondary tuning peaks responsible for finer details in the formation.

The second approach for the present circuit employs a transient voltage V imposed on circuit 10, and subsequent measurement of circuit current is performed by current loop 24. The current is measured in any mode of the voltage V, i.e., due to its leading or falling edge. Measurements on the falling edge are preferable as in this case, the overall circuit is exposed to less noise that can be present in the source voltage 12. A transient curve, circuit current versus time after transient occurred is illustrated in FIG. 3.

In this process, the period of oscillations would be identical to the resonance frequency f, overall current magnitude being proportional to the formation resistivity, and decay time constant being determined by both formation load.

Other alteration and modification of the invention will likewise become apparent to those of ordinary skill in the art upon reading the present disclosure, and it is intended that the scope of the invention disclosed herein be limited only by the broadest interpretation of the appended claims to which the inventor is legally entitled.

1. A method for estimating resistivity of a formation, the method comprising:
exciting an alternating current in the formation through non-conductive mud in an open bore hole using a circuit including a known inductor and the non-conductive mud;
measuring a circuit response of the circuit without tuning the circuit to resonance and without identifying a resonance frequency of the circuit; and
computing the complex impedance of the circuit from the circuit response to estimate the resistivity of the formation.

2. The method of claim 1 wherein the circuit is excited using a sweeping frequency;

3. The method of claim 1 wherein the circuit is excited using a transient voltage.

4. The method of claim 1 wherein the circuit response includes a waveform of current flowing in the circuit.

5. The method of claim 1 wherein the circuit further includes a capacitor.
